(19) United States
(12) Patent Application Publication
(10) Pub. No.: US 2026/0135953 A1
(43) Pub. Date: May 14, 2026

(54) INSPECTION SYSTEM AND DISPLAY APPARATUS

(71) Applicant: CANON KABUSHIKI KAISHA, Tokyo (JP)

(72) Inventor: TAKEYUKI SUDA, Chiba (JP)

(21) Appl. No.: 19/377,575

(22) Filed: Nov. 3, 2025

(30) Foreign Application Priority Data
Nov. 12, 2024 (JP) 2024-197521

(51) Int. Cl. H04N 1/00

(52) U.S. Cl. CPC H04N 1/00084; H04N 1/00005; H04N 1/00087; H04N 1/00421; H04N 1/00461; H04N 1/00411; H04N 2201/0094

(57) ABSTRACT

In a first mode, a system discharges a normal sheet with which no defect has been detected to a first unit, discharges a defective sheet with which a defect has been detected to a second unit, discharges a subsequent sheet that is subsequent to the defective sheet to the second unit, re-forms an image that has been formed on the defective sheet, and re-forms an image that has been formed on the subsequent sheet. In a second mode, it discharges a normal sheet to the first unit, discharges a defective sheet to the second unit, discharges a subsequent sheet that is subsequent to the defective sheet and with which no defect has been detected to the first unit, and to re-forms an image that has been formed on the defective sheet.

### BACKGROUND

### Field of the Technology

The present disclosure relates to an inspection system and a display apparatus.

### DESCRIPTION OF THE RELATED ART

Conventionally, an inspection system has been known in which an image-forming apparatus forms an image on a sheet and an inspection apparatus disposed downstream of the image-forming apparatus inspects the sheet during job execution. The inspection performed during job execution is also called in-line inspection. In the in-line inspection, the inspection apparatus optically reads a sheet on which an image has been formed to generate read image data, and determines whether the printed image is adequate or not by analyzing the read image data. Typically, a defective sheet determined to have a defect is discharged to a discharge destination that is different from a discharge destination for normal sheets.

Japanese Patent Laid-Open No. 2023-048841 discloses a system capable of performing off-line inspection that is performed independently of job execution in addition to the in-line inspection. In the system of Japanese Patent Laid-Open No. 2023-048841, a so-called purge and recovery mode can be selected for the in-line inspection. In the purge and recovery mode, when a defect is detected while executing a job over a plurality of pages, the defective sheet and subsequent sheets being processed are discharged to an escape tray, and images for the pages corresponding to the defective sheet and subsequent sheets are re-formed on new sheets. Since such re-formation of images, that is, a recovery operation conserves an order of pages of the printed product, a user is saved from doing a work of rearranging sheets of the printed product irrespective of whether there was a defect or not.

However, in the purge and recovery mode described in Japanese Patent Laid-Open No. 2023-048841, in a case where there is no need to conserve the order of pages, purging not only the defective sheet but also some subsequent sheets results in the purged subsequent sheets wasted. Such waste can be avoided if the user does not select the purge and recovery mode but selects a purge mode, however, the recovery operation will not be performed in the purge mode. In addition, a user does not always appropriately select an operation mode.

### SUMMARY

In light of the foregoing, the present disclosure is to provide an improved mechanism for assisting selection of an appropriate operation mode in an inspection system.

According to an aspect, an inspection system, comprising: an image-forming unit configured to form an image on a sheet; an inspection unit configured to inspect a sheet on which an image has been formed by the image-forming unit; two or more discharge units to which sheets inspected by the inspection unit are discharged; a setting unit configured to receive a setting related to the inspection; and a control unit configured to control image formation by the image-forming unit and discharge of sheets to the two or more discharge units, wherein the control unit is configured to: in a first operation mode, discharge a normal sheet with which no defect has been detected by the inspection unit to a first discharge unit; discharge a defective sheet with which a defect has been detected by the inspection unit to a second discharge unit; discharge at least one subsequent sheet that is subsequent to the defective sheet to the second discharge unit; cause the image-forming unit to re-form an image that has been formed on the defective sheet; and cause the image-forming unit to re-form an image that has been formed on the at least one subsequent sheet, and in a second operation mode, discharge a normal sheet with which no defect has been detected by the inspection unit to the first discharge unit; discharge a defective sheet with which a defect has been detected by the inspection unit to the second discharge unit; discharge at least one subsequent sheet that is subsequent to the defective sheet and with which no defect has been detected by the inspection unit to the first discharge unit; and cause the image-forming unit to re-form an image that has been formed on the defective sheet, wherein the setting related to the inspection includes a setting related to variable data inspection, the variable data inspection being based on matching with variable data that is different per page, and wherein the control unit is configured to cause a display apparatus to display a message regarding selection of the first operation mode or the second operation mode on the basis of the setting related to the variable data inspection. A corresponding display apparatus is also provided.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic diagram for overview of an inspection system according to an embodiment;

FIG. 2 is a schematic diagram for an example of a configuration of the inspection system according to an embodiment;

FIG. 3 is a block diagram illustrating an example of a particular configuration of inspection-related functions according to an embodiment;

FIG. 4 is an explanatory diagram illustrating an example of a configuration of variable data used in variable data inspection;

FIG. 5 is an explanatory diagram illustrating an example of a configuration of a screen for selecting a correct image data-set;

FIG. 6 is an explanatory diagram illustrating an example of a configuration of a screen for setting inspection areas;

FIG. 7 is an explanatory diagram illustrating an example of a configuration of a screen for detailed settings of an inspection area of variable data inspection;

FIG. 8 is an explanatory diagram illustrating an example of a configuration of a screen for operation settings of an inspection function;

FIG. 9A is an explanatory diagram illustrating an example of a message about suggestion of changing an operation mode to non-ordered recovery;

FIG. 9B is an explanatory diagram illustrating an example of a message about automatic change of an operation mode to non-ordered recovery;

FIG. 10 is an explanatory diagram illustrating an example of a configuration of a screen for detailed settings of an inspection area according to a certain modification example;

FIG. 11 is a flowchart illustrating an example of a flow of inspection setting processing according to an embodiment;

FIG. 12 is a flowchart illustrating an example of a flow of inspection preparation processing according to an embodiment;

FIG. 13 is a flowchart illustrating an example of a flow of in-line inspection processing according to an embodiment; and

FIG. 14 is an explanatory diagram illustrating an example of a configuration of a screen that may be displayed during execution of an in-line inspection.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### <1. Overview of System>

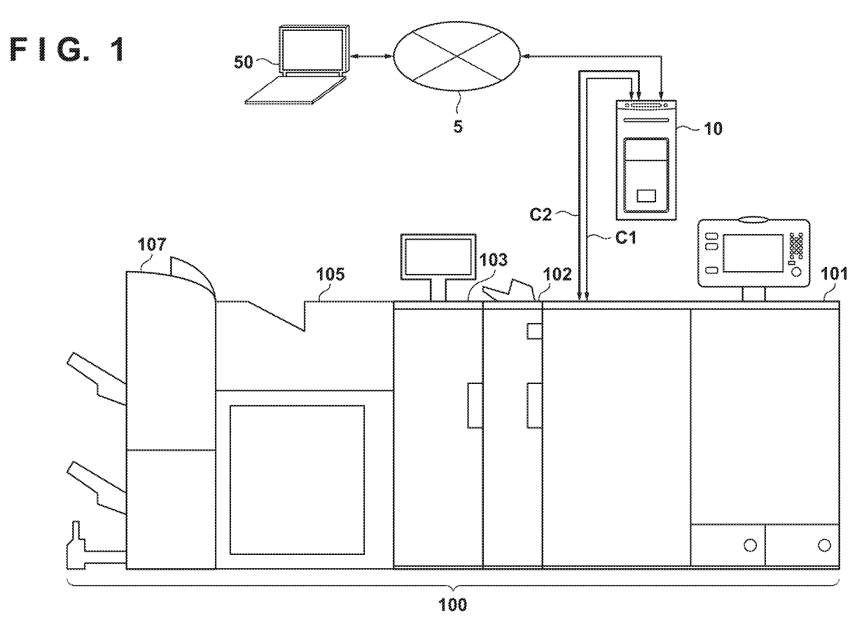

In this section, a system to which the technology according to the present disclosure can be applied will be described. FIG. 1 is a schematic diagram for overview of an inspection system 100 according to an embodiment. In FIG. 1, in addition to the inspection system 100, an external controller 10 and a client personal computer (PC) 50 are illustrated. In the present embodiment, the inspection system 100 is constituted by an image-forming apparatus 101 with apparatuses equipped with supplementary functions (also referred to as accessories) coupled thereto. The image-forming apparatus 101 may be a printer or a multifunction peripheral (MFP), for example. In the example of FIG. 1, the inspection system 100 includes the image-forming apparatus 101, an inserter 102, an inspection apparatus 103, a stacker 105, and a finisher 107.

The client PC 50 is connected in a communication-enabling manner to the external controller 10 via a network 5. The network 5 may be any kind of network such as a local area network (LAN), the Internet, or a virtual private network (VPN), for example. The external controller 10 is connected in a communication-enabling manner to the image-forming apparatus 101 of the inspection system 100 via a LAN cable C1 and a video cable C2. It should be noted that the LAN cable C1 and the video cable C2 may not necessarily be separate cables, and may be integrated into a single cable.

A printer driver is installed in the client PC 50. The printer driver is invoked by an application operating in the client PC 50, converts data designated as a target of printing into data in a form of a predetermined printing description language (for example, a page description language), and transmits the data to the external controller 10 along with a printing command.

The external controller 10 receives the printing command and input image data from the client PC 50, and issues a print job to the inspection system 100. The external controller 10 may perform image processing such as analysis on the input image data, rasterization, color conversion, correction, and binarization. The external controller 10 may be denoted as an image processing controller, a digital front-end (DFE), a print server, or the like. In the present embodiment, the external controller 10 functions as a display apparatus that perform display related to inspection in the inspection system 100, and provides a user interface (UI) for receiving settings related to the inspection from a user. The details of the functions of the external controller 10 will be further described below.

It should be noted that the external controller 10 may not necessarily exist, That is, the client PC 50 may be configured such that the client PC 50 can directly communicate with the inspection system 100, and a print job may be issued directly from the client PC 50 to the inspection system 100. In this case, the image processing such as analysis on the input image data and rasterization may be performed by the inspection system 100 (for example, the image-forming apparatus 101).

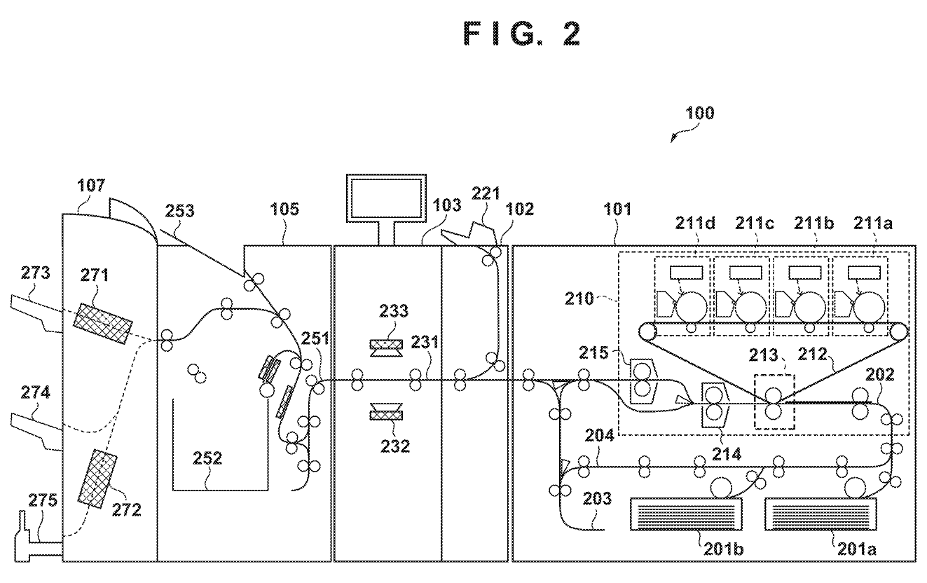

FIG. 2 illustrates an example of the configuration of the inspection system 100 in more detail. The image-forming apparatus 101 is an apparatus that forms an image on a sheet. The image-forming apparatus 101 includes paper feeding units 201a, 201b, an image-forming unit 210, and a conveyance mechanism. Each of the paper feeding units 201a and 201b picks up a sheet from a bundle of sheets contained in the unit one by one to feed the sheet to a conveyance path 202.

The image-forming unit 210 includes image-making units 211a, 211b, 211c and 211d, an intermediate transfer belt 212, a secondary transfer unit 213, a first fixing unit 214, and a second fixing unit 215. The image-making units 211a, 211b, 211c and 211d form toner images of respective color components, namely, yellow (Y), magenta (M), cyan (C) and black (K). As the image-making units 211a, 211b, 211c and 211d have a configuration in common to each other, the configuration of the image-making units 211a will be described here as an example. The image-making unit 211a forms an electrostatic latent image on a surface of a charged photosensitive drum by exposing the photosensitive drum with light (for example, laser light) modulated in accordance with the input image data. The image-making unit 211a develops the electrostatic latent image on the surface of the photosensitive drum by supplying the electrostatic latent image with toner to form a yellow toner image. The toner images of respective color components formed by the image-making units 211a, 211b, 211c and 211d are sequentially transferred to the intermediate transfer belt 212 in a superimposed manner (primary transfer), thereby a full-color toner image is formed. The intermediate transfer belt 212 conveys the full-color toner image to a secondary transfer position in synchronization with a timing when a sheet reaches the secondary transfer position of the secondary transfer unit 213. The secondary transfer unit 213 transfers the toner image from the intermediate transfer belt 212 at the secondary transfer position to a first surface of the sheet.

The first fixing unit 214 has a roller (or a belt) that is heated by a heater, and fixes the toner image to the sheet by melting the toner of the toner image while sandwiching and conveying the sheet. Depending on a type of the sheet, the sheet is conveyed to a path that passes through the second fixing unit 215 in a case where further fixing processing is needed. The second fixing unit 215 also has a roller (or a belt) that is heated by a heater, and enhances fixability of the toner image to the sheet while sandwiching and conveying the sheet.

In a case where double-sided printing is designated, the sheet is guided to a reverse conveyance path 203 where its traveling direction is reversed, and is conveyed to a double-sided conveyance path 204. Then, the sheet returns to the conveyance path 202 with its front and rear surfaces inverted, and a toner image is transferred, by the secondary transfer unit 213, to the second surface of the sheet that has reached the secondary transfer position. The sheet that has passed through the first fixing unit 214 (and the second fixing unit 215) with the toner image(s) fixed to its one or both sides is output from the image-forming apparatus 101 to the inserter 102. The details of the functions of the image-forming apparatus 101 will be further described below.

The inserter 102 accepts a sequence of sheets sequentially output from the image-forming apparatus 101, and inserts an additional sheet to a position designated in a print job. The sheet to be inserted is fed from an insert tray 221 disposed at the top of the inserter 102. The sequence of sheets and inserted sheet(s) are output from the inserter 102 to the inspection apparatus 103.

The inspection apparatus 103 inspects a sheet on which an image has been formed by the image-forming apparatus 101. In the example of FIG. 2, the inspection apparatus 103 includes a conveyance path 231, a first reading unit 232 and a second reading unit 233. The sheet accepted from the inserter 102 is conveyed along the conveyance path 231, and passes through a reading position between the first reading unit 232 and the second reading unit 233. The first reading unit 232 reads the first surface of the sheet to generate a read image of the first surface. The second reading unit 233 reads the second surface of the sheet to generate a read image of the second surface. The first reading unit 232 and the second reading unit 233 may be contact image sensors (CISs) or line scan cameras, for example. The inspection apparatus 103 determines whether there is a defect in these read images or not as described in detail below. A sheet with which no defect has been detected is treated as a normal sheet, and a sheet with which a defect has been detected is treated as a defective sheet. Both of the normal and defective sheets are output from the inspection apparatus 103 to the stacker 105.

The stacker 105 is an apparatus in which sheets as a printed product can be stacked and contained. In the example of FIG. 2, the stacker 105 includes a conveyance path 251, a stack tray 252, and an escape tray 253. The stack tray 252 is a discharge unit to which normal sheets may be discharged. The escape tray 253 is a discharge unit to which defective sheets may be discharged. A sheet accepted from the inspection apparatus 103 to the conveyance path 251 is discharged to the stack tray 252 or the escape tray 253 depending on a result of the inspection for the sheet. However, in a case where a setting has been made to perform post-processing for the print job, the normal sheets are output to the finisher 107 instead of being discharged to the stack tray 252. The stacker 105 may also include a sheet-reversing mechanism for switching between face-down paper discharge and face-up paper discharge for the sheets to be discharged to the stack tray 252.

The finisher 107 is an apparatus that performs post-processing such as stapling, punching, or bookbinding, for example. In the example of FIG. 2, the finisher 107 includes a first post-processing unit 271, a second post-processing unit 272, and discharge trays 273, 274 and 275. The first post-processing unit 271 provides stapling and punching functions, for example. The second post-processing unit 272 provides a saddle-stitching bookbinding function, for example. A bundle of sheets for which post-processing designated for the print job has been performed is discharged to the discharge tray 273, 274 or 275. Each of the discharge trays 273, 274 and 275 may have a lifting up and down mechanism.

### <2. Configuration Example of Inspection-Related Functions>

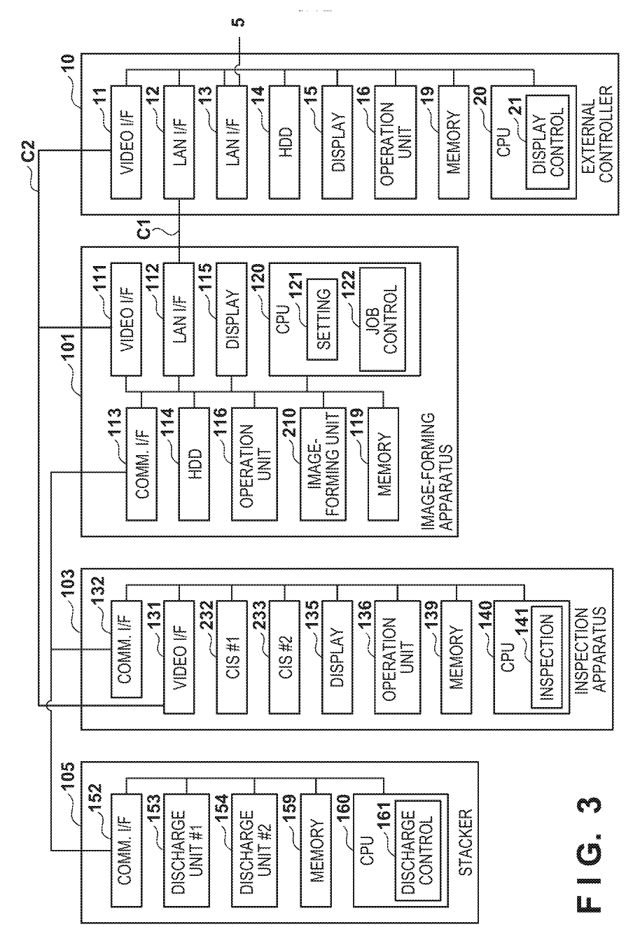

FIG. 3 is a block diagram illustrating an example of a particular configuration of inspection-related functions according to the present embodiment. In FIG. 3, an example of functional configurations of the external controller 10, the image-forming apparatus 101, the inspection apparatus 103, and the stacker 105 which are mainly involved in in-line inspection in the inspection system 100 is illustrated.

### <2-1. External Controller>

The external controller 10 includes a video interface (I/F) 11, a LAN I/F 12, a LAN I/F 13, an HDD 14, a display 15, an operation unit 16, a memory 19, and a CPU 20. These constituent elements are connected to each other via an internal bus.

The video I/F 11 is a communication means for image communication with the image-forming apparatus 101 and the inspection apparatus 103 via the video cable C2. The LAN I/F 12 is a communication means for control communication with the image-forming apparatus 101 via the LAN cable C1. The LAN I/F 13 is a communication means for external communication via the network 5. The hard disk drive (HDD) 14 is a storage means including a storage medium that can store large-scale data. The display 15 is a display means for displaying information and an image. The operation unit 16 is an operation means that receives operations and information inputs by a user. The operation unit 16 may be a set of input devices such as a keyboard, a button, and a switch, for example. The display 15 and the operation unit 16 may be provided in an integrated manner as a touch panel. The memory 19 provides a storage region for computation by the CPU 20. The central processing unit (CPU) 20 provides various functions of the external controller 10 by loading computer programs stored in the HDD 14 to the memory 19 and executing them. The functions provided by the CPU 20 may include, for example, reception of a printing command from an external apparatus, image processing on input image data, issuance of a print job to the inspection system 100, and reception of inspection-related settings. It should be noted that the image processing on input image data may be provided by a dedicated image processing circuit (not illustrated).

In the example of FIG. 3, the CPU 20 functions as a display control unit 21. The display control unit 21 causes the display 15 to display a screen for a UI of the inspection system 100, for example. The user can input the inspection-related settings by operating the input devices of the operation unit 16. The inspection system 100 performs inspection in accordance with the settings received in this manner. Some examples of the UI provided by the display control unit 21 will be further described below.

### <2-2. Image-Forming Apparatus>

The image-forming apparatus 101 includes a video I/F 111, a LAN I/F 112, a communication I/F 113, an HDD 114, a display 115, an operation unit 116, a memory 119, a CPU 120, and an image-forming unit 210. These constituent elements are connected to each other via an internal bus. The image-forming apparatus 101 may further include a reading means that optically reads a document although it is not illustrated in FIGS. 2 and 3.

The video I/F 111 is a communication means for image communication with the external controller 10 and the inspection apparatus 103 via the video cable C2. The LAN I/F 112 is a communication means for control communication with the external controller 10 via the LAN cable C1. The communication I/F 113 is a communication means for control communication with the inspection apparatus 103 and the stacker 105 (as well as the other accessories). The HDD 114 is a storage means including a storage medium that can store large-scale data. The display 115 is a display means for displaying information and an image. The operation unit 116 is an operation means that receives operations and information inputs by a user. The display 115 and the operation unit 116 may be provided in an integrated manner as a touch panel. The memory 119 provides a storage region for computation by the CPU 120. The CPU 120 provides various control functions of the image-forming apparatus 101 by loading computer programs stored in the HDD 114 to the memory 119 and executing them. The functions provided by the CPU 120 may include control of image-forming operation in the image-forming unit 210, control of inspection in the inspection apparatus 103, control of discharge operation in the stacker 105, and control of operation of the other accessories of the inspection system 100. The control of image-forming operation may include, for example, paper feeding control, conveyance control, exposure control, transfer control, and fixing control. The CPU 120 may cause the display 115 to display setting contents for a print job to be executed, a status of a print job being executed, and a report for a print job that has been executed.

In the example of FIG. 3, the CPU 120 functions as a setting unit 121 and a job control unit 122. The setting unit 121 receives, from the external controller 10, settings related to print jobs to be executed in the inspection system 100. In a case where in-line inspection is enabled in a print job, the settings related to the print job include a setting related to inspection. For example, the job control unit 122 controls execution of print jobs in the inspection system 100 in accordance with the settings received by the setting unit 121. For example, the job control unit 122 controls the image-forming unit 210 to form an image on a sheet that is based on input image data. In a case where in-line inspection is enabled in a print job, the job control unit 122 causes the inspection apparatus 103 to inspect a sheet on which an image has been formed by the image-forming unit 210, and controls discharge of the sheet to two or more discharge units in the stacker 105 on the basis of a result of the inspection. The control of discharge of sheets in the in-line inspection will be further described below.

### <2-3. Inspection Apparatus>

The inspection apparatus 103 includes a video I/F 131, a communication I/F 132, a display 135, an operation unit 136, a memory 139, a CPU 140, the first reading unit 232, and the second reading unit 233. These constituent elements are connected to each other via an internal bus.

The video I/F 131 is a communication means for image communication with the external controller 10 and the image-forming apparatus 101 via the video cable C2. The communication I/F 132 is a communication means for control communication with the image-forming apparatus 101 and the stacker 105. The display 135 is a display means for displaying information and an image. The operation unit 136 is an operation means that receives operations and information inputs by a user. The display 135 and the operation unit 136 may be provided in an integrated manner as a touch panel. The memory 139 provides a storage region for computation by the CPU 140. The CPU 140 provides an inspection function of the inspection apparatus 103 by loading computer programs stored in a certain storage medium to the memory 139 and executing them.

In the example of FIG. 3, the CPU 140 functions as an inspection unit 141. As an example, it is assumed that in-line inspection is performed in a print job in which single-sided printing is designated. In this case, the inspection unit 141 obtains, from the first reading unit 232, read image data of a first surface of a sheet on which an image has been formed by the image-forming apparatus 101. Then, the inspection unit 141 determines whether there is a defect in the read image of the first surface on the basis of the obtained read image data. For example, the inspection unit 141 compares the read image with a correct image obtained in advance, and determines that there is a defect in the read image when a result of the comparison satisfies a predetermined condition. The correct image may be generated from the input image data by the external controller 10. Alternatively, the correct image may be generated by optically reading a sheet on which the image has been appropriately formed. The correct image data is, for example, obtained via the video I/F 131 in advance, and stored in the memory 139. In the present specification, such inspection based on comparison between a read image and a correct image is referred to as image inspection.

Furthermore, in the present embodiment, the inspection unit 141 is enabled to perform variable data inspection. The variable data inspection is inspection based on matching with variable data that is different per page. In the variable data inspection, one or more inspection areas are set in a page for a job over a plurality of pages. In addition, variable data that varies from page to page is associated with each inspection area. Then, the inspection unit 141 compares, for each of the inspection areas, the variable data associated with the inspection area with data detected within the inspection area in the read image, and determines whether there is a defect in the read image or not on the basis of a result of the comparison. The detection of data within an inspection area may be performed, for example, by optical character recognition (OCR), or by reading information encoded in a (one-dimensional or two-dimensional) visible code such as a bar code.

In a case where double-sided printing is designated, the inspection unit 141 performs the image inspection based on comparison with a correct image described above and the variable data inspection also for read image data of a second surface of the sheet obtained from the second reading unit 233.

As described above, a sheet with which no defect has been detected by the inspection unit 141 is treated as a normal sheet, and a sheet with which a defect has been detected for one or more inspection items is treated as a defective sheet. The inspection unit 141 executes inspection sequentially for the sheets accepted from the inserter 102, and reports the result of the inspection for each sheet to the job control unit 122 of the image-forming apparatus 101 via the communication I/F 132. The inspection unit 141 may cause the display 135 to display a status of inspection being executed, and a report for inspection that has been executed. The settings related to such inspection will be further described below.

### <2-4. Stacker>

The stacker 105 includes a communication I/F 152, a first discharge unit 153, a second discharge unit 154, a memory 159, and a CPU 160. These constituent elements are connected to each other via an internal bus.

The communication I/F 152 is a communication means for control communication with the image-forming apparatus 101 and the inspection apparatus 103. The first discharge unit 153 and the second discharge unit 154 may correspond to the stack tray 252 and the escape tray 253, respectively, for example. Alternatively, any discharge tray described above disposed in the finisher 107 may be used as the first discharge unit 153 or the second discharge unit 154. In a modification example, the first discharge unit 153 and the second discharge unit 154 may be different discharge positions on the same tray. The memory 159 provides a storage region for computation by the CPU 160. The CPU 160 provides a discharge control function of the stacker 105 by loading computer programs stored in a certain storage medium to the memory 159 and executing them.

In the example of FIG. 3, the CPU 160 functions as a discharge control unit 161. The discharge control unit 161 causes each of sheets on which images have been formed in a print job to be discharged to the first discharge unit 153 or the second discharge unit 154 in accordance with commands from the job control unit 122 of the image-forming apparatus 101, for example. In a case where the in-line inspection is performed, the discharge destination of each sheet may be switched depending on the inspection result output from the inspection unit 141 of the inspection apparatus 103. As described in the next section, the discharge destination of each sheet in the in-line inspection is determined depending on an operation mode selected in the print job.

It should be noted that the memory and the HDD of each apparatus illustrated in FIG. 3 are not limited to the above-described examples, and may be any combination of volatile and non-volatile computer-readable storage media (for example, a RAM, a ROM, an HDD, an SSD, USB memory, and the like). In addition, each of such storage media may be installed within the apparatus, or may be attached externally.

### <3. Details of Inspection>

As described above, the inspection in the inspection system 100 may include the variable data inspection in addition to the image inspection based on comparison between a read image and a correct image. In this section, details of settings for those kinds of inspection received via a UI and the inspection performed in accordance with the settings will be described.

### <3-1. Image Inspection>

A correct image to be compared with a read image of each sheet is obtained by the inspection unit 141 prior to execution of the inspection. In a case where a print job spans N pages (N is a natural number), typically, a set of correct images of the N pages is obtained. The inspection unit 141 may treat, for in-line inspection, an image of each page represented by input image data of a print job as a correct image. Alternatively, a pre-registered set of correct images (a set selected from one or more sets) may be designated as a set of correct images to be used in a print job (hereinafter, referred to as correct image data-set).

The image inspection may include, for example, inspection for one or more of the following inspection items:

difference in color

difference in density

positional misalignment

stripe or blur

print dropout

The inspection of these inspection items may be performed, for example, based on comparison between pixel values per pixel or pixel group, and comparison between positions of objects in the images extracted using edge detection results. Particular techniques for the inspection may be similar to publicly-known techniques, and thus descriptions of the particular techniques are omitted here.

### <3-2. Variable Data Inspection>

In the variable data inspection, as described above, one or more inspection areas are set in a page for a job over a plurality of pages, and variable data that changes per page is associated with each inspection area. Hereinafter, printing invoices to be sent monthly by an insurance company to automobile insurance policyholders is taken as an example to explain settings related to the variable data inspection.

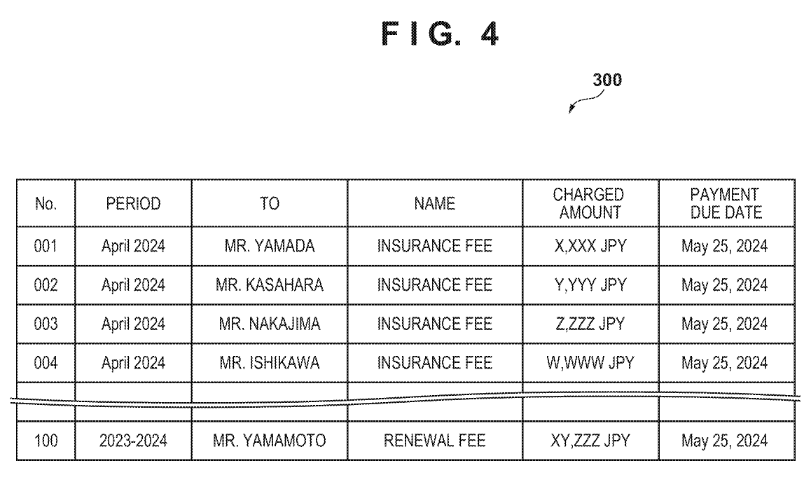

FIG. 4 illustrates variable data 300 for inspection in invoice printing as an example of the variable data. The variable data may be data described in comma separated value (CSV) format or any other structured format, for example. The variable data 300 has six columns of “NUMBER (No.)”, “PERIOD”, “TO”, “NAME”, “CHARGED AMOUNT” and “PAYMENT DUE DATE”. Each row other than the table heading of the variable data 300 corresponds to each one of one hundred policyholders to whom the invoices are sent, and values of the six columns of each row define variable character strings to be printed in six fields within one invoice.

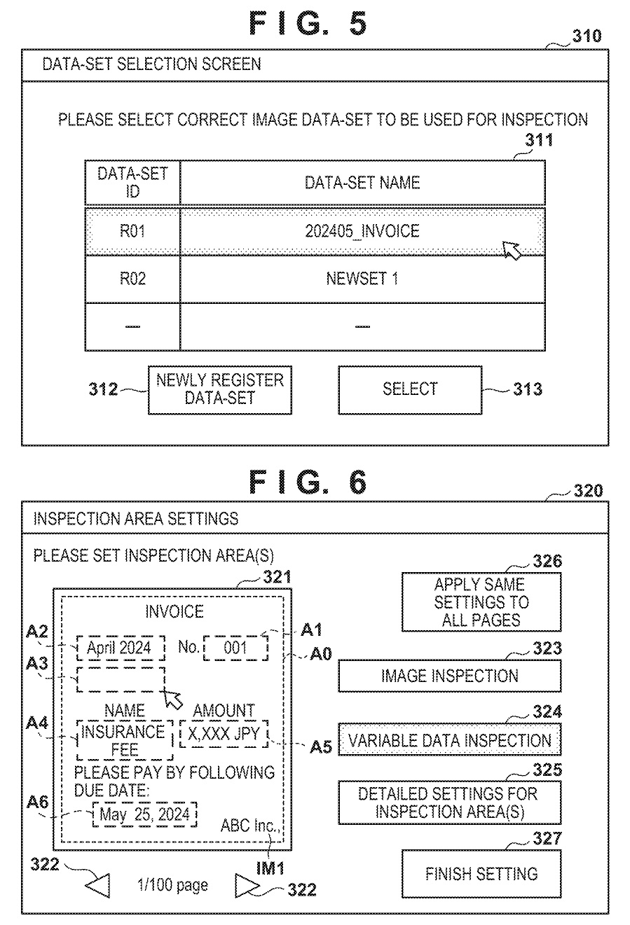

Setting of the variable data inspection may be performed on the same inspection setting screen as that for setting the image inspection. Inspection setting is typically started with a user selecting a correct image data-set for use in the inspection. FIG. 5 is an explanatory diagram illustrating an example of a configuration of a screen for selecting a correct image data-set. The data-set selection screen 310 illustrated in FIG. 5 includes a data-set list 311, a button 312 and a button 313. The data-set list 311 is a list of identifiers (IDs) and names of correct image data-sets that have already been registered in the inspection system 100. The button 312 is a button for invoking a screen for registering a new correct image data-set in the inspection system 100. The button 313 is a button for selecting any correct image data-set displayed on the data-set list 311 as a data-set to be used in the inspection and transitioning to a subsequent setting screen. For example, when a user selects a data-set identified by the ID “R01” and operates the button 313, the data file of the selected data-set is opened, and a screen for setting inspection areas described next may be displayed.

FIG. 6 is an explanatory diagram illustrating an example of a configuration of a screen for setting inspection areas. Note that, in this example, target areas for inspection can be set not only for the variable data inspection but also for the image inspection. The inspection area setting screen 320 illustrated in FIG. 6 includes a preview section 321 and buttons 322 to 327. The preview section 321 is a region in which a preview of one of correct images included in a correct image data-set is displayed. In the example of FIG. 6, a preview of a correct image IM1 of the first page out of one hundred pages in total is displayed in the preview section 321. The pair of buttons 322 are buttons for switching a page of a correct image displayed in the preview section 321.

The button 323 is a button operated when an inspection area is set for the image inspection. For example, the user can set an inspection area to be subject to the image inspection on the displayed page by operating the button 323 and then designating an intended range in the preview section 321 by a drag operation. In the example of FIG. 6, an inspection area A0 is set as an inspection area for the image inspection.

The button 324 is a button operated when an inspection area is set for the variable data inspection. For example, the user can set an inspection area to be subject to the variable data inspection on the displayed page by operating the button 324 and then designating an intended range in the preview section 321 by a drag operation. In the example of FIG. 6, inspection areas A1 to A6 are set as inspection areas for the variable data inspection.

The button 325 is a button for transitioning to a detailed setting screen for each inspection area set in the preview section 321. For example, when the user selects the inspection area A3 and operates the button 325, a screen for detailed settings of the inspection area for the variable data inspection described next may be displayed.

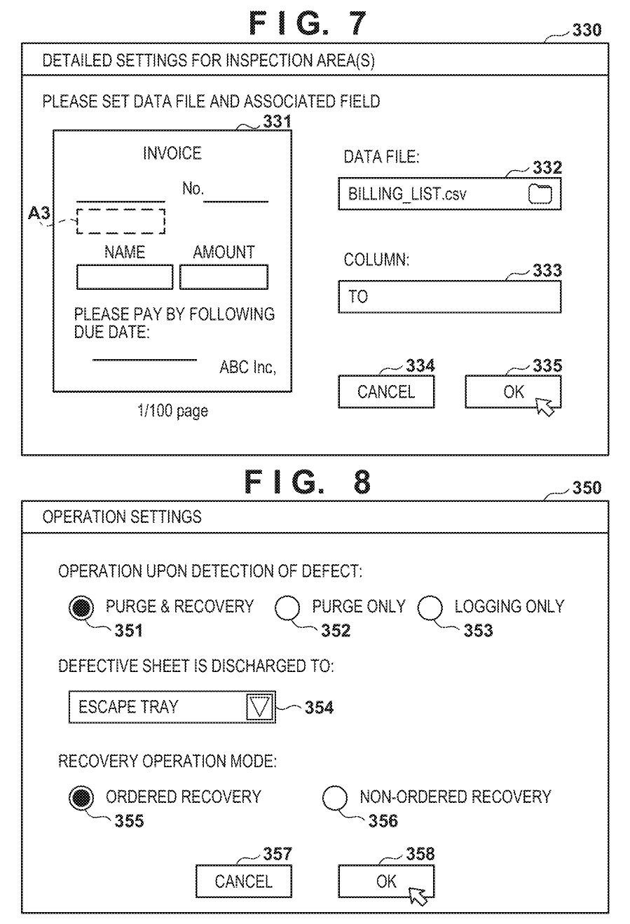

FIG. 7 is an explanatory diagram illustrating an example of a configuration of a screen for detailed settings of an inspection area of variable data inspection. The detailed setting screen 330 illustrated in FIG. 7 includes a preview section 331, a file selection field 332, a column selection field 333, a button 334 and a button 335. The preview section 331 is a region in which a preview of a correct image of the page that has been selected on the inspection area setting screen 320. The file selection field 332 is a field for selecting a data file in which variable data to be associated with the inspection area A3 is described. The column selection field 333 is a field for selecting a column at which character strings to be compared with data detected within the inspection area A3 is described in the data file selected in the file selection field 332. In the example of FIG. 7, a column “TO” in a data file with a filename "BILLING_LIST.csv” (for example, the variable data 300 of FIG. 4) is selected. The button 334 is a button for canceling the settings done on the detailed setting screen 330 and returning to the inspection area setting screen 320. The button 335 is a button for registering the settings done on the detailed setting screen 330 in the system and returning to the inspection area setting screen 320. It should be noted that designation of a range of each inspection area may also be performed in the preview section 331 of the detailed setting screen 330.

Referring back to FIG. 6, the user invokes the detailed setting screen 330 for each of the inspection areas A1 to A6 to register variable data to be associated therewith. In the example of FIG. 6, the columns “No.”, “PERIOD”, “NAME”, “CHARGED AMOUNT” and “PAYMENT DUE DATE” of the variable data 300 are associated with the inspection areas A1, A2, A4, A5 and A6, respectively. Then, in the preview section 321, a preview of corresponding character strings of the first page of correct images (that is, character strings of the first record except for the table heading) are displayed at the positions of these inspection areas. It should be noted that detailed settings may be done also for the inspection area A0 for the image inspection (for example, effective inspection item(s), an inspection level, and so on), but descriptions thereof are omitted herein.

The button 326 is a button for applying the same settings of the inspection area(s) to all of the pages of the correct image data-set. The user is allowed to set an inspection area separately in each page of the correct image data-set, in which case the user operates the buttons 322 to switch between pages and sets an inspection area in each page. Meanwhile, the user is also allowed to set an inspection area in common for all pages, in which case the user operates the button 326 after setting one or more inspection areas in one page. Then, the setting unit 121 makes a copy of the settings of the inspection areas of that page to apply the copy to all of the other pages. In this manner, the task to repeatedly set inspection areas across a plurality of pages is no longer needed, which mitigates the burden of the user’s setting work.

When all of the settings of the image inspection and the variable data inspection for the selected correct image data-set have been completed, the user operates the button 327. Then, the setting unit 121 registers the received settings in the memory in association with the correct image data-set. After that, when execution of a print job is started, the inspection unit 141 executes the in-line inspection in accordance with the registered settings.

### <3-3. Multiple Operation Modes for In-line Inspection>

The invoices printed using the variable data 300 of FIG. 4 are separately sent to respective destinations. Hence, the output order of the invoices has no special constraint, and there will be no inconvenience even if the invoices are stacked on a discharge destination tray in a different order. This is contrastive to a case of a print job including bookbinding performed as post-processing, where an output order of sheets has a constraint. In a case where a defect is detected in in-line inspection in a print job of which output order is constrained, in order to conserve the appropriate output order of sheets, not only the defective sheet but also one or more subsequent sheets already in processing need to be temporarily purged (for example, discharged to the escape tray). The images corresponding to the purged sheets are re-formed on new sheets, ant the sheets are discharged to a normal discharge destination unless there is a defect. In the present specification, such a recovery operation which conserves the output order is referred to as ordered recovery. However, if the ordered recovery is performed for a print job of which output order is not constrained, some subsequent sheets successfully printed without any defect are also purged and wasted. Or, if only purging of the defective sheet is performed without recovery, a user will be bothered because the user need to instruct the system to re-form the image corresponding to the defective sheet on a new sheet after the end of the print job. Accordingly, in the present embodiment, the inspection system 100 offers non-ordered recovery in addition to the above-described ordered recovery which can be selected by the user as an operation mode with recovery in in-line inspection.

The ordered recovery (first operation mode) includes the following basic operations:

the image-forming apparatus 101 sequentially forms images on sheets;

the inspection apparatus 103 sequentially inspects the sheets on which the images have been formed;

normal sheets with which no defect has been detected are discharged to the first discharge unit;

in a case where a defect has been detected:

a defective sheet is discharged to the second discharge unit; and

at least one subsequent sheet that is subsequent to the defective sheet is discharged to the second discharge unit

(a subsequent sheet already in processing is discharged to the second discharge unit without being inspected);

the image-forming apparatus 101 re-forms the image that has been formed on the defective sheet; and

the image-forming apparatus 101 re-forms an image that has been formed on the above at least one subsequent sheet.

The job control unit 122 of the image-forming apparatus 101 controls the above operations in the ordered recovery in conjunction with the inspection unit 141 of the inspection apparatus 103 and the discharge control unit 161 of the stacker 105. A sheet on which the image has been re-formed by the image-forming apparatus 101 is inspected by the inspection unit 141 again and discharged to the first discharge unit if it is normal, and discharged to the second discharge unit (together with at least one subsequent sheet at the point in time) if there is a defect.

The non-ordered recovery (second operation mode) includes the following basic operations:

the image-forming apparatus 101 sequentially forms images on sheets;

the inspection apparatus 103 sequentially inspects the sheets on which the images have been formed;

normal sheets with which no defect has been detected are discharged to the first discharge unit;

in a case where a defect has been detected:

a defective sheet is discharged to the second discharge unit; and

at least one subsequent sheet that is subsequent to the defective sheet is discharged to the first discharge unit (as long as no defect is detected for the sheet)

(a subsequent sheet already in processing is inspected, and discharged to the second discharge unit if a defect is detected); and

the image-forming apparatus 101 re-forms the image that has been formed on the defective sheet.

The job control unit 122 of the image-forming apparatus 101 controls the above operations in the non-ordered recovery in conjunction with the inspection unit 141 of the inspection apparatus 103 and the discharge control unit 161 of the stacker 105. A sheet on which the image has been re-formed by the image-forming apparatus 101 is inspected by the inspection unit 141 again and discharged to the first discharge unit if it is normal, and discharged to the second discharge unit if there is a defect.

Of course, in addition to the ordered recovery and the non-ordered recovery, there may be some other operation modes as well that are selectable in the inspection system 100. Examples of such other operation modes include a mode in which only a defective sheet is purged without performing recovery (re-formation of the image corresponding to the purged sheet), and a mode in which only logging and reporting on the inspection result are performed without performing recovery and purging.

FIG. 8 is an explanatory diagram illustrating an example of a configuration of a screen for operation settings of the inspection function in the inspection system 100. In the example of FIG. 8, the operation setting screen 350 includes radio buttons 351 to 353, a pull-down menu 354, radio buttons 355, 356, a cancel button 357, and an OK button 358. The radio buttons 351 to 353 are buttons for designating whether to perform recovery or not and whether to perform purge or not when a defect has been detected in inspection. A user who prefers performing purge and recovery selects the radio button 351. A user who prefers not performing recovery and performing purge only selects the radio button 352. A user who prefers not performing recovery and purge and only recording logs (and outputting a report) selects the radio button 353. In a case where the radio button 351 or 352 is selected and purge is to be performed, the pull-down menu 354 is enabled. The pull-down menu 354 is an object for designating a discharge destination to which a purged sheet is discharged (the second discharge unit) from among a plurality of candidates. In the example of FIG. 8, the escape tray 253 has been designated. In a case where the radio button 351 is selected and recovery is to be performed, the radio buttons 355, 356 are enabled. The radio buttons 355, 356 are buttons for designating whether to conserve an output order of sheets or not at the time of recovery. A user who prefers conservation of the output order, that is, the ordered recovery selects the radio button 355. On the other hand, a user who prefers the non-ordered recovery selects the radio button 356. The cancel button 357 is a button for canceling the settings done on the operation setting screen 350 and closing the screen. The OK button 358 is a button for registering the settings done on the operation setting screen 350 in the system and closing the screen. It should be noted that a default operation mode for the time of detecting a defect, that is, an operation mode selected in a situation where no specific operation mode has been set by a user may be the ordered recovery, for example.

For a print job of which output order is not constrained, a wasteful situation that well-printed sheets following a defective sheet are purged can be avoided if the user appropriately selects the non-ordered recovery on the operation setting screen 350. However, a user does not always appropriately select an operation mode. For example, as in the example of printing and sending invoices described above, in a case where an inspection area of the variable data inspection is set in common for multiple pages, it is highly likely that the printed products of the pages are separately treated.

Therefore, in the present embodiment, the inspection system 100 is configured to determine whether the currently-selected operation mode for recovery operation is appropriate or not on the basis of the settings related to the variable data inspection, and to suggest a change of or automatically change the operation mode as needed. The operation mode that can be selected for the recovery operation may be the ordered recovery or the non-ordered recovery. Such suggestion of a change or automatic change may be notified to the user by a message displayed on a screen. This makes it possible to reduce a risk that the in-line inspection is performed in an inappropriate operation mode for a print job and to suppress waste of sheets. Of course, users may be given options to accept or reject the suggestion, or to revert the automatic change.

In the present embodiment, an example is mainly described where the job control unit 122 of the image-forming apparatus 101 causes a display apparatus to display a message regarding selection of the ordered recovery or the non-ordered recovery on the basis of the setting related to the variable data inspection. However, in another embodiment, the display control unit 21 of the external controller 10 or the inspection unit 141 of the inspection apparatus 103 may have a function to cause a display apparatus to display a message regarding selection of the ordered recovery or the non-ordered recovery. The display apparatus herein may be a part of the inspection system 100 (for example, the display 115 or 135), or may be external to the system (for example, the display of the client PC 50 or the display 15 of the external controller 10).

Herein, it is assumed that input image data of a certain print job spans a plurality of pages. The number of printed copies may be one or more. It is also assumed that the ordered recovery is a default mode or has been selected by a user. Under such a situation, the two embodiment examples described below can be conceived. First, in a first embodiment example, the setting unit 121 causes the display 15 of the external controller 10 to display the UI screens described using FIGS. 5 to 7, and registers the inspection-related settings in accordance with user inputs received via the operation unit 16. The inspection-related settings may include settings related to the variable data inspection such as one or more inspection areas and association between each inspection area and variable data. For example, when the button 326 of the inspection area setting screen 320 is operated, the setting unit 121 sets an inspection area of the variable data inspection in common for a plurality of pages. In this case, the job control unit 122 causes the display 15 to display a message suggesting to a user that the non-ordered recovery be selected for the print job.

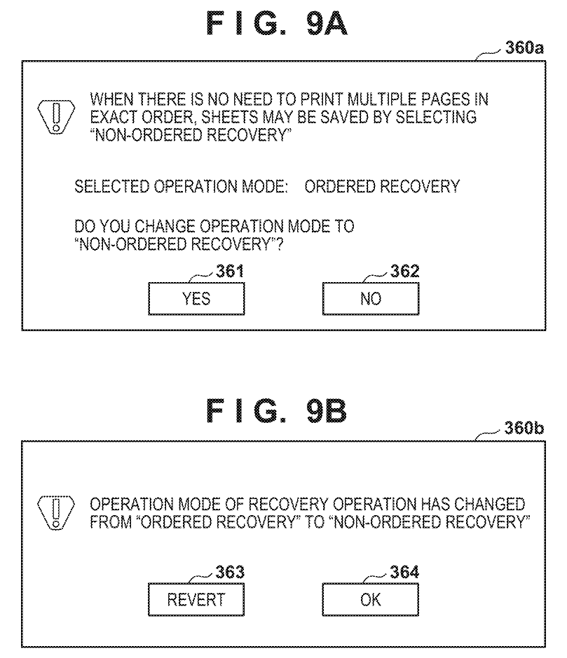

FIG. 9A illustrates an example of a message about suggestion of changing an operation mode to the non-ordered recovery. In the example of FIG. 9A, the message 360a includes a text explaining to a user that, when there is no need to print multiple pages in the exact order, sheets may be saved by selecting the non-ordered recovery. In addition, the message 360a includes a text that suggests changing the operation mode from the ordered recovery to the non-ordered recovery, as well as a YES button 361 and a NO button 362. The setting unit 121 receives an input for selecting an operation mode from the user after the message 360a is displayed by the display 15. For example, a user who prefers accepting the suggestion and changing the operation mode to the non-ordered recovery selects the YES button 361. The setting unit 121 changes the operation mode to the non-ordered recovery when the YES button 361 is operated. On the other hand, a user who prefers rejecting the suggestion and keeping the operation mode as the ordered recovery selects the NO button 362. The setting unit 121 keeps the operation mode as the ordered recovery unchanged when the NO button 362 is operated.

Also in a second embodiment example, under the above-described situation, the setting unit 121 causes the display 15 of the external controller 10 to display the UI screens described using FIGS. 5 to 7, and registers the inspection-related settings in accordance with user inputs received via the operation unit 16. The setting related to the inspection may include a setting related to the variable data inspection. For example, when the button 326 of the inspection area setting screen 320 is operated, the setting unit 121 sets an inspection area of the variable data inspection in common for a plurality of pages. In this case, the job control unit 122 causes the display 15 to display a message notifying a user that the non-ordered recovery is automatically selected for the print job.

FIG. 9B illustrates an example of a message about automatic change of an operation mode to the non-ordered recovery. In the example of FIG. 9B, the message 360b includes a text that notifies the user that the operation mode has been changed from the ordered recovery to the non-ordered recovery, as well as a REVERT button 363 and an OK button 364. The setting unit 121 receives a user input via the button 363 or the button 364 after the message 360b is displayed by the display 15. For example, a user who prefers reverting the operation mode in response to the notification selects the button 363. The setting unit 121 reverts the operation mode back to the ordered recovery when the button 363 is operated. On the other hand, a user who accepts the change selects the OK button 364. When the OK button 364 is operated, the change of the operation mode to the non-ordered recovery is confirmed. It should be noted that, in the second embodiment example, only a message about the automatic change of the operation mode may be displayed and a further user input does not need to be received.

An opposite situation to the situation described above is also considered. That is, it is assumed that input image data of a certain print job spans a plurality of pages, but the non-ordered recovery is a default mode or has been selected by a user. Under such a situation, in the first embodiment example, the job control unit 122 may suggest the user selecting the ordered recovery for the print job in a case where inspection areas of the variable data inspection are set in different forms for the plurality of pages in accordance with user inputs. Alternatively, in the second embodiment example, the job control unit 122 may notify the user that the ordered recovery is automatically selected for the print job in a case where inspection areas of the variable data inspection are set in different forms for the plurality of pages in accordance with user inputs.

The job control unit 122 may automatically select the non-ordered recovery irrespective of the settings related to the variable data inspection for a print job that spans a single page and a plurality of copies. In a case where input image data of a print job consists only of a single page, there is no need to conserve an output order among the plurality of copies of that page in most cases. Hence, the system automatically selects the non-ordered recovery so that the effort for the user to change the settings can be reduced and the possibility of the sheets being wasted can be avoided.

In a modification example, the setting unit 121 may receive a setting designating whether an order of pages should be conserved in a printed product for each of the one or more inspection areas as a setting related to the variable data inspection. The job control unit 122 may suggest a user selecting the non-ordered recovery for a job over a plurality of pages by a message similar to that in FIG. 9A in a case there is no inspection area designated with an order of pages that should be conserved in the settings. Conversely, the job control unit 122 may suggest a user selecting the ordered recovery for a job over a plurality of pages in a case where there is at least one inspection area designated with an order of pages that should be conserved in the settings.

Alternatively, the job control unit 122 may automatically select the non-ordered recovery and perform notification to a user by a message similar to that in FIG. 9B in a case there is no inspection area designated with an order of pages that should be conserved in the settings. Conversely, the job control unit 122 may automatically select the ordered recovery for a job over a plurality of pages and perform notification to a user in a case where there is at least one inspection area designated with an order of pages that should be conserved in the settings.

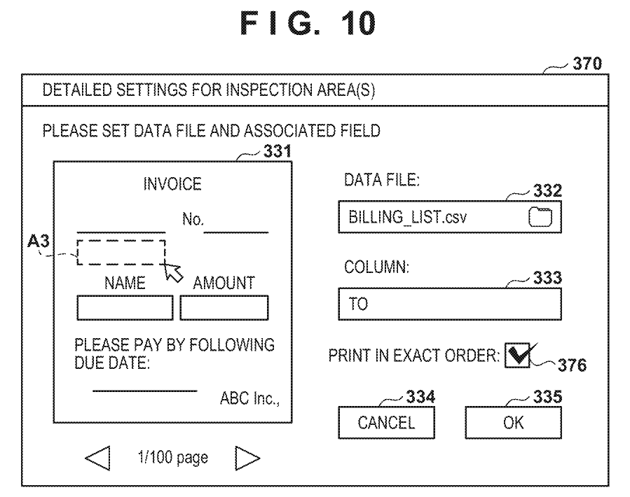

FIG. 10 is an explanatory diagram illustrating an example of a configuration of a screen for detailed settings of an inspection area according to the modification example described above. A detailed setting screen 370 illustrated in FIG. 10 includes a preview section 331, a file selection field 332, a column selection field 333, a button 334, a button 335, and a checkbox 376. The preview section 331, the file selection field 332, the column selection field 333, the button 334 and the button 335 are the same objects as those described in connection with the detailed setting screen 330 of FIG. 7. The checkbox 376 is an object for designating whether an order of pages (output order of variable data) should be conserved in a printed product for an inspection area that is subject to the settings. In the example of FIG. 10, the column “TO” in the data file “BILLING_LIST.csv” is associated with the inspection area A3, and the checkbox 376 is checked. As such, in the printed product, character strings designated by the column “TO” need to be output in the designated order at the position of the inspection area A3. In this case, if the selected operation mode is the non-ordered recovery, the job control unit 122 may suggest the user selecting the ordered recovery or may automatically select the ordered recovery. Meanwhile, in a case where the checkbox 376 is checked for none of the inspection areas and if the selected operation mode is the ordered recovery, the job control unit 122 may suggest the user selecting the non-ordered recovery or may automatically select the non-ordered recovery.

### <4. Flow of Processing>

In this section, some examples of flows of processing that may be performed in the above-described embodiments will be described using flowcharts. Note that ‘S’ means a processing step in each flowchart.

### <4-1. Inspection Setting Processing>

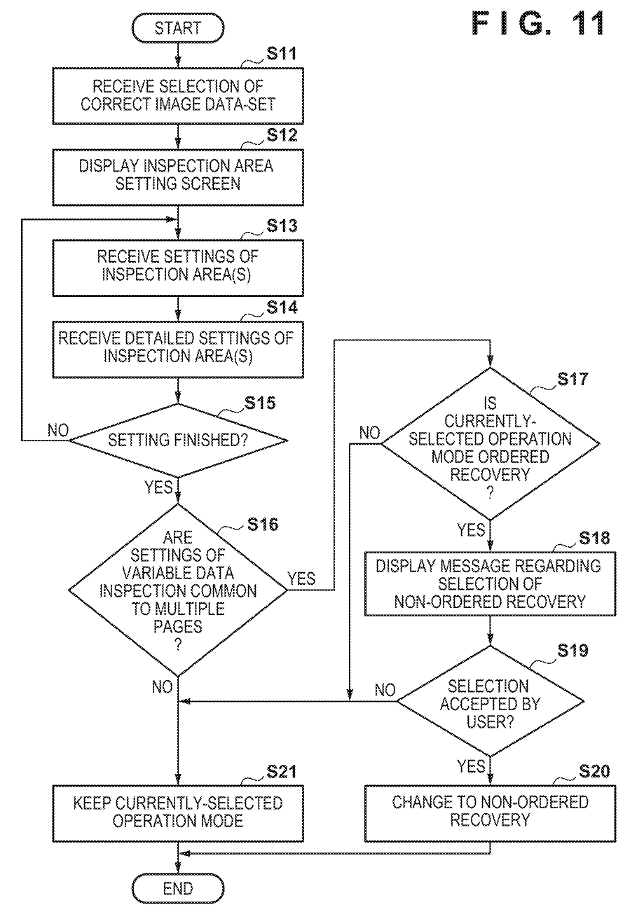

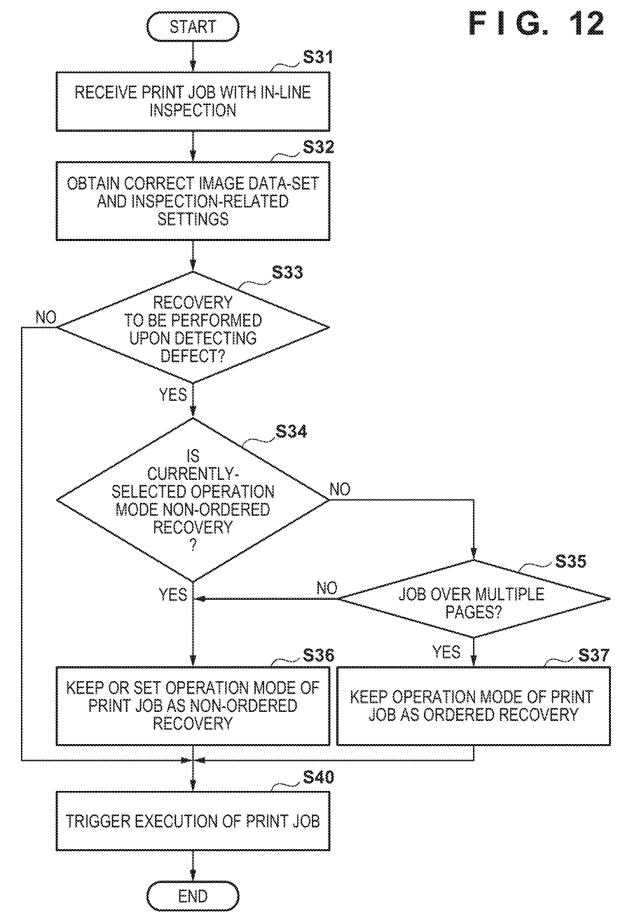

FIG. 11 is a flowchart illustrating an example of a flow of inspection setting processing according to an embodiment. The inspection setting processing of FIG. 11 may be initiated in response to a user invoking the UI for the inspection-related settings from a menu screen of the system, for example. The UI for the inspection-related settings is constituted by, for example, screens displayed on the display 15 by the display control unit 21 and user inputs obtained via the operation unit 16. The setting unit 121 receives the inspection-related settings through a sequence of user interactions using such a UI.

First, in S11, the setting unit 121 receives a selection of a correct image data-set on the data-set selection screen 310. Next, in S12, the display control unit 21 causes the display 15 to display the inspection area setting screen 320. The display control unit 21 causes a preview of one of correct images included in the selected correct image data-set to be displayed in the preview section 321 of the inspection area setting screen 320.

Next, in S13, the setting unit 121 receives a setting of an inspection area on the inspection area setting screen 320. For example, an inspection area that occupies a certain range in the image is set in response to a user’s drag operation. Next, in S14, the display control unit 21 causes the display 15 to display the detailed setting screen 330 or 370, and the setting unit 121 receives detailed settings of the inspection area on the detailed setting screen 330. For example, a designated column of variable data designated by the user is associated with an inspection area of the variable data inspection. S13 and S14 are repeated until the detailed setting is finished for each of one or more inspection areas (S15 - NO).

Upon finishing the detailed setting for all of the inspection areas (S15 - YES), in S16, the inspection setting processing branches depending on whether the inspection areas of the variable data inspection are set in common for multiple pages. In a case where the inspection areas of the variable data inspection have been set in common for the multiple pages, in S17, the display control unit 21 determines whether the currently-selected operation mode is the ordered recovery. In a case where the currently-selected operation mode is the ordered recovery, in S18, the display control unit 21 causes the display 15 to display a message regarding selection of the non-ordered recovery as an operation mode for recovery operation in the in-line inspection. The message herein may be a message that suggests a change of the operation mode to the non-ordered recovery, or a message that notifies of automatic selection of the non-ordered recovery. In a case where the user accepts the selection of the non-ordered recovery (S19 - YES), in S20, the setting unit 121 changes the operation mode from the ordered recovery to the non-ordered recovery.

In a case where the inspection areas of the variable data inspection have been set in different forms to the multiple pages (S16 - NO), in S21, the setting unit 121 keeps the currently-selected operation mode. Alternatively, in a case where the currently-selected operation mode is the non-ordered recovery, a suggestion that the operation mode for recovery operation in the in-line inspection be changed to the ordered recovery may be made to the user.

In a case where the inspection areas of the variable data inspection have been set in common for the multiple pages (S16 - YES), and if the currently-selected operation mode is the non-ordered recovery (S17 - NO), in S21, the setting unit 121 keeps the currently-selected operation mode. In addition, even if the currently-selected operation mode is the ordered recovery (S17 - YES), when the user has rejected the suggestion of changing the operation mode or reverted back the change (S19 - NO), in S21, the setting unit 121 keeps the currently-selected operation mode.

Then, the inspection setting processing of FIG. 11 ends. For example, when the button 327 is operated on the inspection area setting screen 320 of FIG. 6, the inspection system 100 finishes the inspection setting processing and transitions to a state in which it stands by for a print job.

It should be noted that, in some cases, it is unknown at the stage of the inspection setting processing whether a print job to be actually executed spans a plurality of pages or not. This is because a correct image data-set including one hundred correct images, for example, is applicable both to a print job of one page and one hundred copies and to a print job of one hundred pages and one copy. Hence, the setting unit 121 may retain a flag indicating the operation mode for recovery operation determined in the print setting processing of FIG. 11 (for example, an operation mode recommendation flag), and may select an operation mode that is different from the one that has been set in advance, depending on the number of pages of a later-received print job. Such overwriting of the operation mode may be performed in the inspection preparation processing described next.

### <4-2. Inspection Preparation Processing>

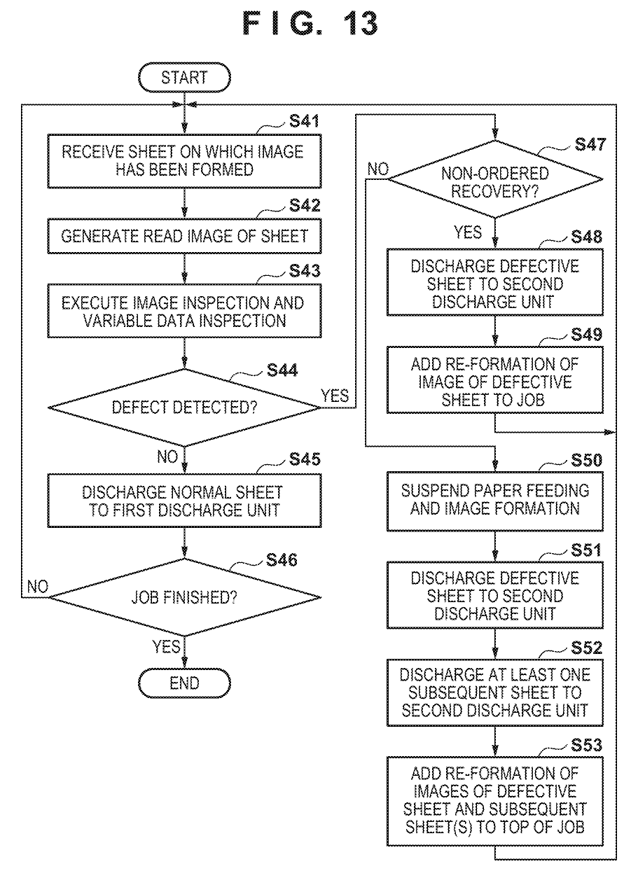

FIG. 12 is a flowchart illustrating an example of a flow of inspection preparation processing according to an embodiment. The inspection preparation processing of FIG. 12 may be initiated in response to the job control unit 122 of the image-forming apparatus 101 receiving a print job with the in-line inspection from the external controller 10, for example.

First, in S31, the job control unit 122 receives, from the external controller 10, a print job with the in-line inspection. The job control unit 122 sets up the image-forming apparatus 101 as well as the inspection apparatus 103 and the stacker 105, which are accessories, in accordance with various job parameters designated in the print job. It should be noted that the inserter 102 does not insert an additional sheet and the finisher 107 is not used herein. For example, the job control unit 122 determines which paper feeding unit is to feed sheets, selects single-sided printing or double-sided printing, and determines to which discharge unit the sheets are to be discharged. For a recovery operation, in addition to a first discharge unit to which normal sheets are to be discharged, a second discharge unit to which defective sheets are to be discharged is determined.

Next, in S32, the job control unit 122 obtains, from the memory, a correct image data-set to be used in the in-line inspection and the inspection-related settings. It is assumed herein that the inspection-related settings include a setting related to the variable data inspection, and the setting related to the variable data inspection includes variable data associated with each of one or more inspection areas. The job control unit 122 outputs the obtained correct image data-set and the inspection-related settings to the inspection unit 141 of the inspection apparatus 103.

Next, in S33, the job control unit 122 determines, on the basis of the obtained inspection-related settings, whether to perform recovery upon detecting a defect in the in-line inspection. In a case where it is to perform recovery upon detecting a defect (the ordered recovery or the non-ordered recovery has been selected), the job control unit 122 makes a final decision on the operation mode on the basis of the currently-selected operation mode and the number of pages of the print job. For example, in a case where the currently-selected operation mode is the non-ordered recovery (S34 - YES), in S36, the job control unit 122 keeps the operation mode for recovery operation of the print job as the non-ordered recovery. In addition, in a case where the currently-selected operation mode is the ordered recovery (S34 - NO) and the print job does not span multiple pages (S35 - NO), in S36, the job control unit 122 sets the operation mode as the non-ordered recovery. Meanwhile, in a case where the currently-selected operation mode is the ordered recovery (S34 - NO) and the print job spans multiple pages (S35 - YES), in S37, the job control unit 122 keeps the operation mode for recovery operation of the print job as the ordered recovery.

Upon finishing the setup of the print job with the in-line inspection described above, in S40, the job control unit 122 notifies the inspection unit 141 of the finally-decided operation mode and triggers execution of the print job.

### <4-3. In-line Inspection Processing>

FIG. 13 is a flowchart illustrating an example of a flow of in-line inspection processing according to an embodiment. The in-line inspection processing of FIG. 13 may be performed by the inspection apparatus 103 in conjunction with the image-forming operation by the image-forming apparatus 101 in response to completion of the inspection preparation processing of FIG. 12.

First, in S41, the inspection apparatus 103 receives one sheet on which an image has been formed by the image-forming apparatus 101 into the conveyance path 231. Next, in S42, the first reading unit 232 reads the first surface of the sheet passing the reading position to generate a read image of the first surface. In a case where both sides of the sheet are to be inspected, the second reading unit 233 reads the second surface of the sheet to generate a read image of the second surface, too. Next, in S43, the inspection unit 141 performs, on the sheet received in S41, the image inspection based on comparison between a read image and a correct image, and the variable data inspection based on matching with variable data that is different per page. The inspection unit 141 knows to which page the image formed on each sheet corresponds to as a result of communication with the job control unit 122, and uses a correct image and a variable data record corresponding to that page, respectively, for the image inspection and the variable data inspection.

In S44, the in-line inspection processing branches depending on whether a defect has been detected or not in S43. In a case where no defect has been detected in the image inspection and the variable data inspection, the processing proceeds S45. Meanwhile, in a case where a defect has been detected in the image inspection or the variable data inspection, the processing proceeds S47.

In S45, the normal sheet is discharged to the first discharge unit (for example, the stack tray 252 of the stacker 105). Next, in S46, it is determined whether the execution of the print job has finished or not. In a case where the execution of the print job has not finished, the processing goes back to S41, a next sheet is received from the image-forming apparatus 101, a read image of the sheet is generated, and the image inspection and the variable data inspection are performed.

The processing in the case of a defect having been detected branches depending on the operation mode for recovery operation in S47. In a case where the operation mode is the non-ordered recovery (S47 - YES), in S48, the defective sheet is discharged to the second discharge unit (for example, the escape tray 253 of the stacker 105). Next, in S49, the inspection unit 141 reports the inspection result to the job control unit 122 so that the image formed on the defective sheet is re-formed. The job control unit 122 adds, to the ongoing job, an operation for re-forming the image formed on the defective sheet. The operation for re-forming may be added to the end of the ongoing job, or may be added to an intermediate point of the job. Afterward, the processing goes back to S41, a next sheet is received from the image-forming apparatus 101, a read image of the sheet is generated, and the image inspection and the variable data inspection are performed. The sheet received at this point may be a sheet that is subsequent to the defective sheet. The subsequent sheet will be discharged to the first discharge unit as a normal sheet if no defect is detected.

In a case where a defect has been detected and the operation mode is the ordered recovery (S47 - NO), in S50, the inspection unit 141 reports the inspection result to the job control unit 122 so that feeding of a new sheet and image formation on it are suspended. In the meantime, the defective sheet is discharged to the second discharge unit in S51, and then at least one subsequent sheet is discharged to the second discharge unit in S52. Next, in S53, the job control unit 122 adds, to the top of the ongoing job, an operation for re-forming the images formed on the defective sheet and at least one subsequent sheet. Afterward, the processing goes back to S41, a next sheet is received from the image-forming apparatus 101, a read image of the sheet is generated, and the image inspection and the variable data inspection are performed. The sheet received first at this point may be a sheet on which the image formed on the defective sheet has been re-formed. This sheet will be discharged to the first discharge unit as a normal sheet if no defect is detected.

When discharge of normal sheets for all the pages including the pages subject to the recovery operation has completed, in S46, it is determined that the execution of the print job has finished. Then, the in-line inspection processing of FIG. 13 ends.

### <4-4. Status Indication during Inspection>

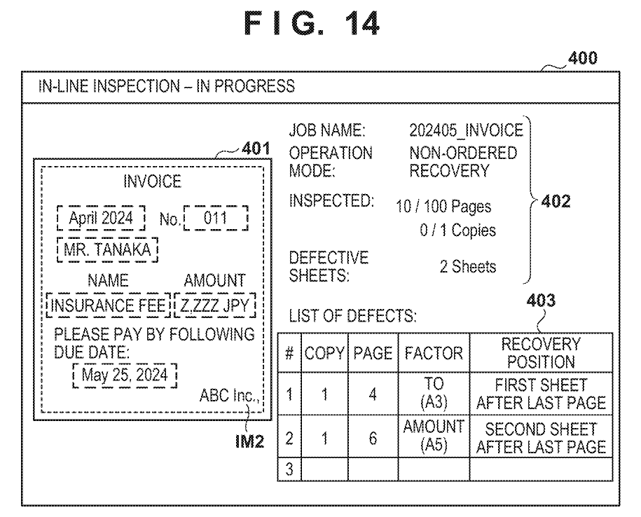

FIG. 14 is an explanatory diagram illustrating an example of a configuration of a screen that may be displayed during execution of the in-line inspection. A status screen 400 illustrated in FIG. 14 includes a preview section 401, a status section 402, and a defect list 403. The preview section 401 is a region in which a preview of the read image of the sheet that is currently inspected is displayed. The status section 402 is a region in which status information including inspection results for the executed inspection is displayed. The defect list 403 is a region in which list information related to a defect that has been detected in the executed inspection

In the example of FIG. 14, a preview of a read image IM2 of the eleventh page out of the one hundred pages in total is displayed in the preview section 401. The status information displayed in the status section 402 includes the name of the print job, the selected operation mode, the number of pages already inspected, the number of copies already inspected, and the number of defective sheets detected. The list information displayed in the defect list 403 includes the copy to which each defective sheet belongs, the corresponding page number, the factor of the detected defect, and the recovery position. The recovery position herein is information indicating to which position the sheet on which the image formed on each defective sheet has been re-formed (and no defect detected in re-inspection for the sheet) is discharged among the sheets (that is, among the bundle of normal sheets) on the first discharge unit. In this way, it is made possible for the user to check, on the screen, identification information of the defective sheet (the copy and page number or the like) with the corresponding recovery position, and thus the user can easily ascertain the position of each page in the bundle of sheets that have been output without conserving its order.

It should be noted that, in a case where the ordered recovery is selected as the operation mode, since the output order of the sheet is conserved in the printed product, the recovery positions may not be indicated in the defect list 403.

### <5. Conclusion>

Thus far, various embodiments and modification examples of the technology according to the present disclosure have been described using FIGS. 1 to 14. In the above-described embodiments, a first operation mode (ordered recovery) and a second operation mode (non-ordered recovery) are provided in an inspection system that performs image re-formation upon detecting a defect (that is, recovery operation). In the first operation mode, immediately after a defective sheet and at least one subsequent sheet that is subsequent to the defective sheet are purged, a sheet on which the image that has been formed on the defective sheet is re-formed is output. Thus, the output order of sheets in a printed product is conserved. For example, the first operation mode is suitable for the case where the order of pages has a constraint as with printed products that assume bookbinding (for example, magazines and books). Meanwhile, in the second operation mode, no subsequent sheet that is subsequent to a defective sheet is purged though this does not conserve the output order of sheets. Thus, waste of sheets is avoided. For example, the second operation mode is suitable for the case where the sheets included in a printed product are treated separately as in the above-described example of printing and sending invoices. Then, the system determines an appropriate operation mode on the basis of settings related to the variable data inspection for a job over a plurality of pages, and causes a display apparatus to display a message regarding selection of the operation mode. Therefore, even when the user does not select an appropriate operation mode in advance, it is possible to ensure an opportunity to optimize the operation mode before executing a job so that waste of sheets can be avoided in a flexible way.

For example, for a job over a plurality of pages, in a situation where the first operation mode is a default mode or selected by a user, selecting the second operation mode may be suggested to the user when an inspection area of the variable data inspection is set in common for the plurality of pages. Alternatively, in a similar situation the second operation mode may be automatically selected when the inspection area of the variable data inspection is set in common for the plurality of pages. According to this configuration, the user no longer needs to change the operation mode from the first operation mode to the second operation mode whenever a job for which the second operation mode is desirable occurs, and thus the burden of the user’s setting work can be mitigated. Such a technique is advantageous particularly in a situation where the first operation mode, that is, the ordered recovery is desirable for a larger percentage of jobs because it makes it easy to keep the setting of a basic operation mode as the first operation mode.

In the above-described embodiments, the second operation mode may be automatically selected for a job over a single page and a plurality of copies because it is significantly likely that the sheets included in a printed product are treated separately. However, for a job that spans a plurality of pages, it is difficult to predict, from the number of pages, how the sheets included in the printed product are treated. In that situation, by considering commonality over a plurality of pages of settings related to the variable data inspection in determining an operation mode, it is possible to appropriately determine a desirable operation mode so that the burden of the user can be mitigated.

In a modification example, a setting designating whether an order of pages should be conserved in a printed product for each of one or more inspection areas is received as a setting related to the variable data inspection. Then, for a job over a plurality of pages, selecting the second operation mode is suggested to the user or the second operation mode is automatically selected in a case where there is no inspection area designated with an order of pages that should be conserved. According to this configuration, it is possible to further enhance adequacy of determination of a desirable operation mode.

### <6. Other Embodiments>

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-197521, filed on November 12, 2024 which is hereby incorporated by reference herein in its entirety.

What is claimed is:

1. An inspection system, comprising:
an image-forming unit configured to form an image on a sheet;
an inspection unit configured to inspect a sheet on which an image has been formed by the image-forming unit;
two or more discharge units to which sheets inspected by the inspection unit are discharged;
a setting unit configured to receive a setting related to the inspection; and
a control unit configured to control image formation by the image-forming unit and discharge of sheets to the two or more discharge units,
wherein the control unit is configured to:
in a first operation mode,
discharge a normal sheet with which no defect has been detected by the inspection unit to a first discharge unit;
discharge a defective sheet with which a defect has been detected by the inspection unit to a second discharge unit;
discharge at least one subsequent sheet that is subsequent to the defective sheet to the second discharge unit;
cause the image-forming unit to re-form an image that has been formed on the defective sheet; and
cause the image-forming unit to re-form an image that has been formed on the at least one subsequent sheet, and
in a second operation mode,
discharge a normal sheet with which no defect has been detected by the inspection unit to the first discharge unit;
discharge a defective sheet with which a defect has been detected by the inspection unit to the second discharge unit;
discharge at least one subsequent sheet that is subsequent to the defective sheet and with which no defect has been detected by the inspection unit to the first discharge unit; and
cause the image-forming unit to re-form an image that has been formed on the defective sheet,
wherein the setting related to the inspection includes a setting related to variable data inspection, the variable data inspection being based on matching with variable data that is different per page, and
wherein the control unit is configured to cause a display apparatus to display a message regarding selection of the first operation mode or the second operation mode on the basis of the setting related to the variable data inspection.

2. The inspection system according to claim 1, wherein the control unit is configured to, for a job over a plurality of pages, in a situation where the first operation mode is a default mode or selected by a user, cause the display apparatus to display a message that suggests the user selecting the second operation mode for the job when an inspection area of the variable data inspection is set in common for the plurality of pages.

3. The inspection system according to claim 2, wherein the setting unit is configured to receive an input for selecting an operation mode from the user after the display apparatus displayed the message that suggests selecting the second operation mode.

4. The inspection system according to claim 1, wherein the control unit is configured to, for a job over a plurality of pages, in a situation where the first operation mode is a default mode or selected by a user, cause the display apparatus to display a message that notifies the user of the second operation mode being automatically selected for the job when an inspection area of the variable data inspection is set in common for the plurality of pages.

5. The inspection system according to claim 1, wherein the control unit is configured to select the second operation mode for a job over a single page and a plurality of copies.

6. The inspection system according to claim 1, wherein the inspection unit is configured to inspect a sheet on which an image has been formed by the image-forming unit by determining whether a read image of the sheet has a defect,
the variable data inspection is an inspection for each of one or more inspection areas set in a page, the inspection being based on comparison between variable data associated with the inspection area and data detected within the inspection area in the read image, and
the variable data varies for each page.

7. The inspection system according to claim 6, wherein the setting unit is configured to receive a setting designating whether an order of pages should be conserved in a printed product for each of the one or more inspection areas as the setting related to the variable data inspection, and
the control unit is configured to, for a job over a plurality of pages, suggest a user selecting the second operation mode or automatically select the second operation mode in a case where the setting related to the variable data inspection includes no inspection area designated with an order of pages that should be conserved.

8. The inspection system according to claim 7, wherein the control unit is configured to, for a job over a plurality of pages, suggest the user selecting the first operation mode or automatically select the first operation mode in a case where the setting related to the variable data inspection includes at least one inspection area designated with an order of pages that should be conserved.

9. The inspection system according to claim 1, wherein the control unit is configured to:
in the first operation mode, discharge the at least one subsequent sheet to the second discharge unit without causing the inspection unit to inspect the at least one subsequent sheet, and
in the second operation mode, cause the inspection unit to inspect the at least one subsequent sheet, and discharge a subsequent sheet with which no defect has been detected to the first discharge unit and a subsequent sheet with which a defect has been detected to the second discharge unit.

10. The inspection system according to claim 1, wherein the control unit is configured to, in a case where the second operation mode is selected for a job over a plurality of pages, present, to a user, information indicating to which position among sheets on the first discharge unit a sheet on which an image formed on the defective sheet has been re-formed is discharged.

11. A display apparatus that performs display related to inspection in an inspection system including an image-forming unit configured to form an image on a sheet and an inspection unit configured to inspect a sheet on which image has been formed by the image-forming unit,
wherein the inspection system is configured to:
in a first operation mode,
discharge a normal sheet with which no defect has been detected by the inspection unit to a first discharge unit;
discharge a defective sheet with which a defect has been detected by the inspection unit to a second discharge unit;
discharge at least one subsequent sheet that is subsequent to the defective sheet to the second discharge unit;
cause the image-forming unit to re-form an image that has been formed on the defective sheet; and
cause the image-forming unit to re-form an image that has been formed on the at least one subsequent sheet, and
in a second operation mode,
discharge a normal sheet with which no defect has been detected by the inspection unit to the first discharge unit;
discharge a defective sheet with which a defect has been detected by the inspection unit to the second discharge unit;
discharge at least one subsequent sheet that is subsequent to the defective sheet and with which no defect has been detected by the inspection unit to the first discharge unit; and
cause the image-forming unit to re-form an image that has been formed on the defective sheet,
wherein the inspection in the inspection system includes variable data inspection that is based on matching with variable data that is different per page,
the display apparatus comprising:
an operation unit configured to receive a setting related to the variable data inspection; and
a display control unit configured to cause a screen to display a message regarding selection of the first operation mode or the second operation mode on the basis of the setting related to the variable data inspection.

12. The display apparatus according to claim 11, wherein the display control unit is configured to, for a job over a plurality of pages, in a situation where the first operation mode is a default mode or selected by a user, cause the screen to display a message that suggests the user selecting the second operation mode for the job when an inspection area of the variable data inspection is set in common for the plurality of pages.

13. The display apparatus according to claim 12, wherein the operation unit is configured to receive an input for selecting an operation mode from the user after the display apparatus displayed the message that suggests selecting the second operation mode.

14. The display apparatus according to claim 11, wherein the display control unit is configured to, for a job over a plurality of pages, in a situation where the first operation mode is a default mode or selected by a user, cause the screen to display a message that notifies the user of the second operation mode being automatically selected for the job when an inspection area of the variable data inspection is set in common for the plurality of pages.

15. The display apparatus according to claim 11, wherein the operation unit is configured to receive a setting designating whether an order of pages should be conserved in a printed product for each of one or more inspection areas as the setting related to the variable data inspection, and
the display control unit is configured to, for a job over a plurality of pages, cause the screen to display a message that suggests a user selecting the second operation mode or a message that notifies a user of the second operation mode being automatically selected in a case where the setting related to the variable data inspection includes no inspection area designated with an order of pages that should be conserved.

16. The display apparatus according to claim 11, wherein the display control unit is configured to, in a case where the second operation mode is selected for a job over a plurality of pages, cause the screen to display information indicating to which position among sheets on the first discharge unit a sheet on which an image formed on the defective sheet has been re-formed is discharged.
